(19) United States
(12) Patent Application Publication
(10) Pub. No.: US 2009/0289492 A1
(43) Pub. Date: Nov. 26, 2009

(54) Static Crushing Method, Aid for Static Crushing Used for the Crushing Method, and Filling Tool

(75) Inventors: Tetsuya Sakaki, Tokyo (JP); Noriyuki Kozakai, Tokyo (JP); Takayuki Kaneyoshi, Tokyo (JP); Yuuji Suzuki, Tokyo (JP)

Correspondence Address: CHAPMAN AND CUTLER, 111 WEST MONROE STREET, CHICAGO, IL, 60603, US

(73) Assignee: SUMITOMO OSAKA CEMENT CO., LTD, TOKYO (JP)

(21) Appl. No.: 11/887,488

(22) PCT Filed: Mar. 15, 2006
(86) PCT No.: PCT/JP2006/305168

§ 371 Date: Sep. 28, 2007

(30) Foreign Application Priority Data
Mar. 28, 2005 (JP) 2005-092990
Jul. 28, 2005 (JP) 2005-218174
Aug. 2, 2005 (JP) 2005-223602

(51) Int. Cl. B02C 19/18; E01C 23/12; E21C 37/12; E21C 37/00

(52) U.S. Cl. 299/10; 299/20

(57) ABSTRACT

A static crushing method capable of extremely safely and efficiently performing crushing operation by efficiently crushing the surface of an object to be crushed, an aid for static crushing used for the crushing method, and a filling tool. The static crushing method comprises the steps of forming a drilled hole (1) in the object to be crushed, filling an expandable crushing material in the drilled hole (1), and crushing the object to be crushed by the inflation of the crushing material, and is characterized in that the aid for static crushing having a bottom plate (3) disposed in the drilled hole, a top plate (20) larger in area than the bottom plate (3) and disposed on the outside of the drilled hole, and connection means (23) and (21) connecting these plates to each other is used to fill the crushing material, and the crushing material is disposed between the bottom plate and the top plate. Also, the inflatable crushing material is desirably stored in a water-permeable bag body or the top plate (20) is desirably formed larger in area than the mouth of the drilled hole.

### TECHNICAL FIELD

The present invention relates to a static crushing method, an aid for static crushing used for the static crushing method, and a filling tool, and in particular, to a static crushing method according to which drilled holes are provided to an object to be crushed, the drilled holes are filled in with an expandable crushing material, and the object to be crushed is crushed through the expansion of the crushing material, and to an aid for static crushing used for the static crushing method as well as a filling tool.

### BACKGROUND TECHNOLOGY

As the conventional methods, methods for crushing and repairing concrete on the surface of the road, bridges and the like where repairs or improvements are necessary due to damage caused by salt and deterioration due to use over a long period of time, methods for crushing concrete on the surface by physically applying an impact and vibrations, such as a method using a pick hammer and a breaker, and a water jet method have been adopted. The above described crushing methods relate to operations using vibrations, and a problem arises such that fine particles of, for example, concrete are created, making the work environment worse, and furthermore, operations for crushing on the lower surfaces or the vertical surfaces of structures, such as bridges, require a tremendous amount of labor. In addition, operations for crushing using water jet use a large scale apparatus, and cleaning up after the work takes time and effort, and in addition, the cost is high. In particular, operations for the crushing of concrete structures in water take much time and effort.

In addition, according to these methods, there is a possibility that cracking may occur in the inside of the concrete portions which do not require repairs in addition to the portions which require repairs, and there is another possibility that the reinforcing members, such as reinforcing rods, may be damaged due to physical impact and vibrations.

On the other hand, methods for statically crushing a structure, such as concrete, using an expandable material, such as cement, as a crushing material have been proposed. In particular, Patent Documents 1 to 3 disclose a configuration where a crushing material is held between two bodies in plate form made of a top plate and a bottom plate within drilled holes provided in an object to be crushed in order to prevent the crushing material, with which the object to be crushed is filled in, from blowing out and effectively use the pressure when the crushing material expands.

### Patent Document 1: Japanese Unexamined Patent Publication S60 (1985)-85193

### Patent Document 2: Japanese Unexamined Patent Publication S61 (1986)-36463

### Patent Document 3: Japanese Unexamined Patent Publication H9 (1997)-234389

FIG. 1 shows a manner in which a conventional crushing material is held. As shown in FIG. 1, an aid formed of a connection means 5, which is a linking material in rod form or string form between a bottom plate 3 and a top plate 4, is placed inside a drilled hole 1, and an expandable crushing material is placed between the bottom plate 3 and the top plate 4. When the crushing material 2 expands in this configuration, the pressure in the upward and downward directions is held by the bottom plate 3 and the top plate 4 so that the crushing material can be effectively prevented from blowing out from the openings of the drilled hole. In addition, the bottom plate 3 and the top plate 4 function in such a manner that the internal pressure is mainly applied in the direction perpendicular to the direction of the drilling of the drilled hole (lateral direction in FIG. 1), making it possible to easily crush the object to be crushed. FIG. 2 shows a state at this time of the pressure being applied to the inner walls and the like of the drilled hole 1.

In the conventional structure, however, the bottom plate and the top plate are formed so as to have the same area in order to prevent the top plate 4 from being lifted up due to the pressure of the expandable crushing material in the upward direction, and in addition, it is necessary for the bottom plate 3 and the top plate 4 to hold the expandable crushing material without leakage, and therefore, as shown in FIG. 1, the top plate is placed in a location inside the drilled hole 1. In addition, in the case where a drilled hole 1 is provided in an object to be crushed, chipped portions 6 are easily created around the opening of the drilled hole due to the chipping of the corners and a deviation of the axis of the drill, and thus, the top plate 4 is placed in a location further inside the drilled hole 1.

In the case where such a conventional aid is used, as denoted by 10 in FIG. 2, the pressure distribution inside the drilled hole 1 in the direction perpendicular to the direction of the drilled hole is a pressure distribution 10 of which the center is the center portion in the direction of the drilled hole, where almost no pressure is applied in the vicinity of the opening of the drilled hole (proximity to the chipped portions 6) when the material expands. Therefore, crushing operations use the pressure only from the inside of the object to be crushed, and thus, the time required for crushing becomes long.

### DISCLOSURE OF THE INVENTION

### Problem to be Solved by the Invention

An object of the present invention is to solve the above described problem and provide a static crushing method capable of easily crushing the surface of an object to be crushed and extremely safely and efficiently performing a crushing operation, an aid for static crushing used for the crushing method, and a filling tool.

Another object of the present invention is to provide a static crushing method capable of filling in a drilled hole of an object to be crushed with a static crushing material easily even in the case where the depth of the drilled hole is great and extremely safely and efficiently performing a crushing operation, and a filling tool used for the static crushing method.

Still another object of the present invention is to provide a static crushing method capable of efficiently performing a crushing operation even in the case where there is a cavity or a gap between a drilled hole and the static crushing material.

Yet another object of the present invention is to provide an aid for static crushing capable of easily crushing the surface of an object to be crushed irrelevant of the disparity in the depth of the drilled hole in the object to be crushed and extremely safely and efficiently performing a crushing operation.

An additional object of the present invention is to provide an aid for static crushing capable of more efficiently performing a crushing operation where it becomes easy or unnecessary to temporarily hold the aid for static crushing when the aid is used and suppressing the effect of the expandable pressure on the lower surface of the drilled hole of an object to be crushed.

### Means for Solving Problem

The invention according to claim 1 provides a static crushing method for providing a drilled hole in an object to be crushed, filling in the hole with an expandable crushing material, and crushing the object to be crushed through the expansion of the crushing material, characterized in that an aid for static crushing having a bottom plate placed within a drilled hole, a top plate which has an area greater than that of the bottom plate and is placed on the outside of the drilled hole, and a connection means for connecting the two is used when the drilled hole is filled in with the crushing material so that the crushing material is placed between the bottom plate and the top plate.

Here, static crushing means crushing the entirety or a part of a building, such as of a rock or a concrete structure.

The invention according to claim 2 provides the static crushing method according to claim 1, characterized in that the expandable crushing material is contained inside a water permeable bag body.

The invention according to claim 3 provides the static crushing method according to claim 2, characterized in that the expandable crushing material is integrated with the bottom plate and the connection means or the bottom plate, the top plate and the connection means when the drilled hole of the object to be crushed is filled in with the expandable crushing material.

The invention according to claim 4 provides the static crushing method according to claim 2, characterized in that the drilled hole of an object to be crushed is filled in with the expandable crushing material after water has been added to the expandable crushing material, or water is added to the expandable crushing material in a state of not being hydrated, with which the drilled hole has been filled in.

The invention according to claim 5 provides the static crushing method according to any of claims 1 to 4, characterized in that the bottom plate and the top plate are made to approach each other after the drilled hole of the object to be crushed has been filled in with the expandable crushing material so that the filling ratio of the crushing material is increased between the bottom plate and the top plate.

The invention according to claim 6 provides the static crushing method according to claim 1, characterized in that a static crushing material with an aid for static crushing, which is provided with the aid for static crushing and where the expandable crushing material is contained within a water permeable bag body, and a static crushing material without an aid for static crushing, which is not provided with the aid for static crushing and where the expandable crushing material is contained within a water permeable bag body, are used, the drilled hole is filled in with at least one or more static crushing materials without an aid, and the static crushing material with an aid is placed in the vicinity of the opening within the drilled hole.

The invention according to claim 7 provides the static crushing method according to claim 6, characterized in that the expansion of the static crushing materials without an aid starts expanding at the same time or after the time when the static crushing material with an aid starts expanding.

The invention according to claim 8 provides the static crushing method according to claim 6 or 7, characterized in that the length of a stick of the static crushing material with an aid is no greater than 100 mm.

Here, “the length of a stick of the static crushing material with an aid” means the length between the top plate and the bottom plate in the aid for static crushing.

The invention according to claim 9 provides a filling tool with which a drilled hole is filled in with a static crushing material without an aid in accordance with the static crushing method according to any of claims 6 to 8, comprising a portion in rod form having an outer diameter greater than the inner diameter of the drilled hole and a pressing portion directly or indirectly connected to the portion in rod form, which has an outer diameter greater than the inner diameter of the drilled hole.

The invention according to claim 10 provides the filling tool according to claim 9, characterized in that the distance between the portion in rod form and the pressing portion is adjustable.

The invention according to claim 11 provides the static crushing method according to claim 1, characterized in that a static crushing material with an aid, which is provided with the aid for static crushing and where an expandable crushing material is contained within a water permeable bag body, and a slurry, which is gained by making the static crushing material with an aid absorb water and includes an expandable crushing material, are injected into the drilled hole, and after that, the drilled hole is loaded with the static crushing material with an aid.

The invention according to claim 12 provides the static crushing method according to claim 1, characterized in that a static crushing material with an aid, which is provided with the aid for static crushing and where an expandable crushing material is contained within a water permeable bag body, and a slurry, which is gained by making the static crushing material with an aid absorb water and includes an expandable crushing material, are attached to the static crushing material with an aid, and after that, the drilled hole is loaded with the static crushing material with an aid.

The invention according to claim 13 provides the static crushing method according to claim 1, characterized in that a static crushing material with an aid, which is provided with the aid for static crushing and where an expandable crushing material is contained within a water permeable bag body, and a slurry, which is gained by making the static crushing material with an aid absorb water and includes an expandable crushing material, are attached to the static crushing material with an aid, and the slurry or another slurry, including an expandable crushing material, is injected into the drilled hole, and after that, the drilled hole is loaded with the static crushing material with an aid.

The invention according to claim 14 provides the static crushing method according to any of claims 11 to 13, characterized in that the slurry starts to expand at the time later than the time when the static crushing material with an aid starts to expand.

The invention according to claim 15 provides the static crushing method according to any of claims 11 to 14, characterized in that the viscosity of the slurry is adjusted by means of an added thickener.

The invention according to claim 16 provides the static crushing method according to claim 15, characterized in that the slurry injected into the drilled hole has such a viscosity and a self-shape maintaining property as not to flow out even in the case where the drilled hole is a lateral hole.

The invention according to claim 17 provides an aid for static crushing used in a static crushing method for providing a drilled hole in an object to be crushed, filling in the drilled hole with an expandable crushing material, and crushing the object to be crushed through the expansion of the crushing material, characterized by comprising: a bottom plate placed within the drilled hole; a top plate, which has an area greater than that of the bottom plate and is placed on the outside of the drilled hole; and a connection means for connecting the two.

The invention according to claim 18 provides the aid for static crushing according to claim 17, characterized in that the top plate has an area greater than the area of the opening of the drilled hole.

The invention according to claim 19 provides the aid for static crushing according to claim 17 or 18, characterized in that the top plate is formed so as to be freely removable from the connection means.

The invention according to claim 20 provides the aid for static crushing according to any of claims 17 to 19, characterized in that a recess which covers the opening of the drilled hole is created in the top plate on the drilled hole side of the object to be crushed.

The invention according to claim 21 provides the aid for static crushing according to any of claims 17 to 20, characterized in that the top plate is formed in such a manner that the connection means allows the top plate to approach or move away from the bottom plate.

The invention according to claim 22 provides the aid for static crushing according to any of claims 17 to 21, characterized in that the connection means has a fitting for maintaining and securing a state of being connected to the top plate.

The invention according to claim 23 provides the aid for static crushing according to any of claims 17 to 22, characterized in that the connection means is provided with a fixation means for fixing the bottom plate, which is pulled toward the top plate.

The invention according to claim 24 provides the aid for static crushing according to claim 23, characterized in that the fixation means makes the connection means moveable only in the direction in which the bottom plate is pulled toward the top plate.

The invention according to claim 25 provides the aid for static crushing according to claim 23 or 24, characterized in that the top plate and the fixation means are integrally formed.

The invention according to claim 26 provides the aid for static crushing according to any of claims 17 to 25, characterized in that the expandable crushing material is contained within a water permeable bag body and placed between the bottom plate and the top plate.

The invention according to claim 27 provides the aid for static crushing according to claim 26, characterized in that the bottom plate is placed within the bag body.

### EFFECTS OF THE INVENTION

In accordance with the invention according to claim 1, a bottom plate placed inside a drilled hole and a top plate which has an area greater than that of the bottom plate and is placed on the outside of the drilled hole are used when the drilled hole is filled with a crushing material, and therefore, the pressure of the crushing material when expanding can be effectively applied to the vicinity of the opening of the drilled hole, and thus, cracking can be accelerated on the surface of the object to be crushed. That is to say, crushing progresses in two stages: (1) the surface cracks and (2) the cracking spreads to the inside. The cracking of the surface in the above described (1) is accelerated when the pressure of the expanding crushing material is applied to the surface, and as a result, the speed of crushing can be increased.

In accordance with the invention according to claim 2, the expandable crushing material is contained within a water permeable bag body, and therefore, it is easy to handle the crushing material, and in addition, it can be extremely easily placed between the bottom plate and the top plate in an aid, and thus, it becomes possible to further improve the workability of the crushing operation.

In accordance with the invention according to claim 3, the expandable crushing material contained in a bag body is integrated with the bottom plate and the connection means or the bottom plate, the top plate and the connection means before the drilled hole of the object to be crushed is loaded with the expandable crushing material, and therefore, it becomes possible for the drilled hole of the object to be crushed to be efficiently loaded with the aid for static crushing or a portion thereof including the bottom plate, the top plate and the connection means together with the expandable crushing material.

In accordance with the invention according to claim 4, the drilled hole of the object to be crushed is filled in with the expandable crushing material contained in a bag body after water is added to the expandable crushing material, or water is added after the drilled hole is filled in with the expandable crushing material in a state of not being hydrated, and therefore, an operation of mixing the crushing material and water becomes unnecessary, unlike the conventional art, and thus, it becomes possible to increase the workers safety.

In accordance with the invention according to claim 5, the drilled hole of the object to be crushed is filled in with an expandable crushing material, and after that, the bottom plate and the top plate are made to approach each other so that the filling rate of the crushing material is increased between the bottom plate and the top plate, and therefore, it becomes possible to achieve a stronger pressure more quickly when the crushing material expands.

In accordance with the invention according to claim 6, a static crushing material with an aid for static crushing, which is provided with the aid for static crushing and where the expandable crushing material is contained within a water permeable bag body, and a static crushing material without an aid for static crushing, which is not provided with the aid for static crushing and where the expandable crushing material is contained within a water permeable bag body, are used, the drilled hole is filled in with at least one or more static crushing materials without an aid, and the static crushing material with an aid is placed in the vicinity of the opening within the drilled hole, and therefore, it is not necessary to use a longer static crushing material with an aid even in the case where the depth of the drilled hole of the object to be crushed is great, and thus, it becomes possible to efficiently destroy the object to be crushed.

In accordance with the invention according to claim 7, in the case where the expansion of the static crushing materials without an aid starts expanding after the time when the static crushing material with an aid starts expanding, the static crushing material with an aid, with which the drilled hole in the vicinity of the opening is filled in, initially expands, providing a state where the drilled hole is firmly closed in the vicinity of the opening. After that, even in the case where the static crushing material without an aid placed inside the drilled hole expands, the drilled hole is closed with the static crushing material with an aid in the vicinity of the opening, and therefore, the expansion progresses inside the drilled hole, making it possible to efficiently destroy the object to be crushed. In addition, the static crushing material without an aid is prevented from blowing out from the opening of the drilled hole, and thus, the operation can be performed extremely safely. In the case where the expansion of the static crushing materials without an aid starts expanding at the same time the static crushing material with an aid starts expanding, though the static crushing material with an aid is slightly pushed out, the force of friction with the wall surface of the drilled hole increases quickly due to the expansion reaction of the static crushing material so that the static crushing material is fixed within the drilled hole, making crushing possible.

In accordance with the invention according to claim 8, the length of a stick of the static crushing material with an aid is no greater than 100 mm, and therefore, the drilled hole can be efficiently loaded with the static crushing material with an aid, and at the same time, it becomes possible to operate the connection means of the aid even in a state of being placed within the drilled hole so that the filling rate of the expandable crushing material can be easily increased.

In accordance with the invention according to claim 9, a filling tool, with which a drilled hole is filled in with a static crushing material without an aid in accordance with the static crushing method, has a portion in rod form having an outer diameter greater than the inner diameter of the drilled hole and a pressing portion directly or indirectly connected to the portion in rod form, which has an outer diameter greater than the inner diameter of the drilled hole, and therefore, it becomes possible to easily fill in the drilled hole with the static crushing material without an aid by placing the static crushing material inside the drilled hole and pressing the static crushing material with the filling tool. In addition, it is difficult for the pressing portion of the filling tool to enter into the drilled hole, and therefore, it becomes possible for the drilled hole to always be filled in with the static crushing material up to a certain depth.

In accordance with the invention according to claim 10, the distance between the portion in rod form and the pressing portion is adjustable, and therefore, it becomes possible to adjust the length between the pressing portion and the end of the portion in rod form in accordance with the length of the used static crushing material with an aid.

In accordance with the invention according to claim 11, a static crushing material with an aid, which is provided with the aid for static crushing and where an expandable crushing material is contained within a water permeable bag body, and a slurry, which is gained by making the static crushing material with an aid absorb water and includes an expandable crushing material, are injected into the drilled hole, and after that, the drilled hole is loaded with the static crushing material with an aid, and therefore, it becomes possible for the slurry including the expandable crushing material to go between the static crushing material with an aid and the inner wall of the drilled hole so as to increase the filling rate of the expandable crushing material within the drilled hole and adjust the pressure of the expandable crushing material to an appropriate pressure when expanding. In particular, it is possible to effectively apply the present invention as the method for filling in a cavity 330 within the drilled hole shown in FIG. 16 with an expandable crushing material.

In accordance with the invention according to claim 12, a static crushing material with an aid, which is provided with the aid for static crushing and where an expandable crushing material is contained within a water permeable bag body, and a slurry, which is gained by making the static crushing material with an aid absorb water and includes an expandable crushing material, are attached to the static crushing material with an aid, and after that, the drilled hole is loaded with the static crushing material with an aid, and therefore, it becomes possible for the slurry including the expandable crushing material to go between the static crushing material with an aid and the inner wall of the drilled hole so as to increase the filling rate of the expandable crushing material within the drilled hole and adjust the pressure of the expandable crushing material to an appropriate pressure when expanding. In particular, it is possible to effectively apply the present invention as the method for filling in a gap 331 within the drilled hole shown in FIG. 16 with an expandable crushing material.

In accordance with the invention according to claim 13, a static crushing material with an aid, which is provided with the aid for static crushing and where an expandable crushing material is contained within a water permeable bag body, and a slurry, which is gained by making the static crushing material with an aid absorb water and includes an expandable crushing material, are attached to the static crushing material with an aid, and the slurry or another slurry, including an expandable crushing material, is injected into the drilled hole, and after that, the drilled hole is loaded with the static crushing material with an aid, and therefore, it becomes possible for the slurry including the expandable crushing material to go between the static crushing material with an aid and the inner wall of the drilled hole so as to increase the filling rate of the expandable crushing material within the drilled hole and adjust the pressure of the expandable crushing material to an appropriate pressure when expanding. In particular, it is possible to effectively apply the present invention as the method for filling in a cavity 330 and a gap 331 within the drilled hole shown in FIG. 16 with an expandable crushing material.

In accordance with the invention according to claim 14, the slurry starts to expand at the time later than the time when the static crushing material with an aid starts to expand, and therefore, the static crushing material with an aid initially expands so as to become of a state of firmly closing the drilled hole in the vicinity of the opening. After that, even in the case where the slurry that has been injected into the drilled hole, in particular, into the cavity 330 shown in FIG. 16 expands, the drilled hole is closed with the static crushing material with an aid in the vicinity of the opening, and therefore, the expansion of the slurry progresses inside the drilled hole, making it possible to efficiently destroy the object to be crushed. In addition, the slurry can be prevented from partially blowing out from the opening of the drilled hole, and thus, the operation can be performed extremely safely.

In addition, since the static crushing material with an aid initially starts expanding, the slurry attached to the surrounding of the static crushing material with an aid is pushed out to the inner wall side of the drilled hole, and thus, the gaps are further filled in with the slurry. As a result, the pressure of the expandable crushing material is effectively used when the expandable crushing material expands, making it possible to efficiently perform the crushing operation.

In accordance with the invention according to claim 15, though it is possible to use a slurry without adjusting the viscosity in the case of a perpendicularly drilled hole, it is preferable for the viscosity to be adjusted by means of an added thickener. The viscosity of the slurry can be adjusted while maintaining the amount of water relative to the expandable crushing material constant, and it becomes possible to prevent the slurry from sagging during the filling operation and effectively prevent the slurry from flowing out from the opening of the drilled hole after the drilled hole is filled in with the slurry.

In accordance with the invention according to claim 16, the slurry injected into the drilled hole has such a viscosity and a self-shape maintaining property as not to flow out even in the case where the drilled hole is a lateral hole, and therefore, the crushing operation using an expandable crushing material can be made possible even when the drilled hole is provided as a lateral hole.

In accordance with the invention according to claim 17, the top plate of the aid for static crushing is placed on the outside of the drilled hole, and therefore, the pressure of the crushing material when expanding can be effectively applied to the vicinity of the opening of the drilled hole, and thus, crushing progresses from the cracks and the like on the surface side of the object to be crushed. As a result, an aid for static crushing which makes it possible to easily crush the surface of the object to be crushed and to perform the crushing operation extremely safely and efficiently can be provided.

In accordance with the invention according to claim 18, the top plate has an area greater than the area of the opening of the drilled hole, and therefore, the opening of the drilled hole is covered with the top plate, and the expandable crushing material pressed by the top plate is more effectively provided in the vicinity of the opening of the drilled hole.

In accordance with the invention according to claim 19, the top plate is formed so as to be freely removable from the connection means, and therefore, it becomes possible to remove the top plate, place the bottom plate and the connection means (for example, a linking material or the like) inside the drilled hole in advance, fill in the drilled hole with an expandable crushing material, and after that, attach the top plate to the connection means. In addition, in the case where an expandable crushing material contained in the below described bag body is handled, it becomes possible to make the connection means penetrate through the bag body or make the bottom plate and the connection means be contained within the bag body, and after that, fill in the bag body with the expandable crushing material and attach the top plate. Furthermore, a top plate which fits the size of the opening of the drilled hole can be selected so as to be connected to the connection means, and thus, an increase in the workability of various types of operations and an increase in the crushing efficiency can be achieved.

In accordance with the invention according to claim 20, a recess which covers the opening of the drilled hole is created in the top plate on the drilled hole side of the object to be crushed, and therefore, the amount of the expandable crushing material contained in the vicinity of the top plate can be increased, and it becomes possible to increase the pressure in the vicinity of the opening of the drilled hole when the expandable crushing material expands.

In accordance with the invention according to claim 21, the top plate is formed in such a manner that the connection means allows the top plate to approach or move away from the bottom plate, and therefore, it becomes possible to increase the filling ratio of the expandable crushing material so that a stronger pressure can be achieved more quickly when the crushing material expands by making the top plate approach the bottom plate, particularly in such a state as to place an expandable crushing material between the top plate and the bottom plate.

In accordance with the invention according to claim 22, the connection means has a fitting for maintaining and securing a state of being connected to the top plate, and therefore, it becomes possible to press the top plate toward the bottom plate side by simply pressing the fitting for securing manually, and thus, the workability increases extremely. Here, the fitting for securing is not particularly limited as long as it has a function of locking the top plate to the connection means, and for example, a push nut, a wing nut and a fixed fitting can be used.

In accordance with the invention according to claim 23, the connection means is provided with a fixation means for fixing the bottom plate, which is pulled toward the top plate, and therefore, it becomes possible to increase the filling rate in the vicinity of the surface of the object to be crushed simply by drilling the object to be crushed so that the depth of the drilled hole is greater than the length of the stick and pulling the bottom plate toward the top plate after the drilled hole is loaded with the aid for static crushing. As a result, an aid for static crushing, which makes it possible to easily crush the surface of the object to be crushed irrelevant of the inconsistency in the depth of the drilled hole and to perform the crushing operation extremely safely and efficiently, can be provided.

In addition, the top plate makes contact with the surface of the object to be crushed, and therefore, it becomes easy or unnecessary to temporarily press the aid for static crushing when the aid is used, and it becomes possible to perform the crushing operation more efficiently. In addition, a gap is created between the lower surface of the drilled hole of the object to be crushed and the bottom plate, and therefore, no pressure is applied to the lower surface of the drilled hole when the crushing material expands.

In accordance with the invention according to claim 24, the fixation means makes the connection means moveable only in the direction in which the bottom plate is pulled toward the top plate, and therefore, it becomes possible to easily perform an operation to increase the filling rate of the expandable crushing material simply by pulling the connection means so that the bottom plate is pulled toward the top plate.

In accordance with the invention according to claim 25, the top plate and the fixation means are integrally formed, and therefore, the number of parts of the aid for static crushing can be reduced and the loading operation can be easily performed simply by pulling the connection means while holding the top plate so that the efficiency in the operation increases.

In accordance with the invention according to claim 26, the expandable crushing material is contained within a water permeable bag body, and therefore, the handling of the crushing material is easy, and in addition, the crushing material can be extremely easily placed between the bottom plate and the top plate in the aid, and thus, it becomes possible to further improve the workability of the crushing operation. The expandable crushing material integrated with the bottom plate and the top plate is immersed in water for use, and thus, the expandable crushing material, which is a strong alkali, can be safely used.

In accordance with the invention according to claim 27, the bottom plate is placed within the bag body, and therefore, no extra opening is created in the bag body other than the opening for the bottom plate and the expandable crushing material to be contained in the bag body, and thus, it becomes possible to reduce the danger of the expandable crushing material leaking from the bag body during the operation.

### BRIEF DESCRIPTION OF THE DRAWINGS

FIG. 1 is a diagram showing a crushing method using an aid for static crushing according to the prior art;

FIG. 2 is a schematic diagram showing a state of the internal pressure caused by the crushing material of FIG. 1;

FIG. 3 is a schematic diagram showing a state of the internal pressure caused by the crushing material in the case where the aid for static crushing according to the present invention is used;

FIG. 4 is a diagram showing a state where the aid for static crushing according to the present invention is arranged in the bag body containing an expandable crushing material;

FIG. 5 is a diagram showing a state where the aid for static crushing of FIG. 4 is contained in a drilled hole 1;

FIG. 6 is a diagram showing a state where the aid for static crushing is arranged in the case where a plate in disc form is used as the top plate;

FIG. 7 is a diagram showing a manner in which the aid for static crushing according to the present invention is inserted into the drilled hole, and the drilled hole is filled in with the crushing material;

FIG. 8 is a schematic diagram showing the state of internal pressure caused by the crushing material in the case where the aid for static crushing according to an application example is used;

FIG. 9 is a diagram showing a state where the bag body containing an expandable crushing material is loaded with the aid for static crushing according to an application example;

FIG. 10 is a diagram showing a state where the aid for static crushing of FIG. 9 is contained within a drilled hole 101;

FIG. 11 is a diagram showing a state where the aid for static crushing according to an application example is loaded in a case where a plate in disc form is used as the top plate;

FIG. 12 is a diagram showing a manner in which the aid for static crushing according to an application example is inserted into a drilled hole, and the drilled hole is filled in with a crushing material;

FIG. 13 is a diagram schematically illustrating the method for static crushing applied to a deeply drilled hole;

FIG. 14 is a diagram schematically showing filling tools used in the method for static crushing of FIG. 13;

FIG. 15 is a diagram showing a method for using the filling tool according to the present invention;

FIG. 16 is a diagram illustrating a manner of a cavity and gaps created in the case when a static crushing material is used;

FIG. 17 is a diagram showing a manner in which the drilled hole is filled in with a static crushing material or the like in accordance with a static crushing method using a slurry of an expandable crushing material; and

FIG. 18 is a diagram illustrating an example of a static crushing method using a slurry of an expandable crushing material.

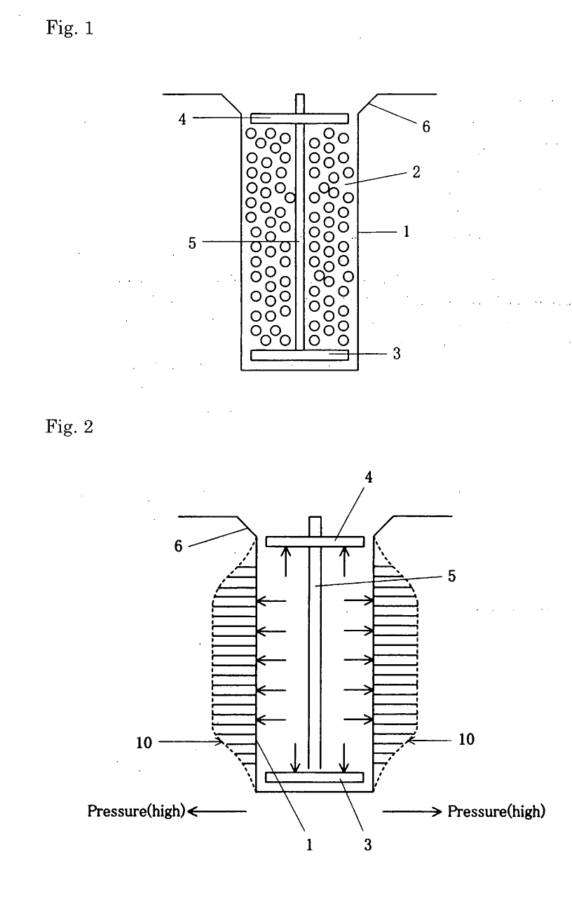

### EXPLANATION OF SYMBOLS

1, 101, 201, 301 drilled holes provided in object to be crushed
2, 102 expandable crushing material
3, 103 bottom plate
4, 20, 30, 104, 120, 130 top plate
5, 23, 105, 123 connection tool
6, 106 chipped portion
10, 22, 110, 122 distribution of pressure
25, 125 bag body
21, 26 push nut
121, 126 fixation means
230, 340 static crushing material with aid
240 static crushing material without aid
250, 252 portion in rod form
251 pressing portion
253 screw
260 filling tool
330 cavity
331 gap
350, 351, 360 slurry

### BEST MODE FOR CARRYING OUT THE INVENTION

The static crushing method and the aid for static crushing used for the static crushing method as well as the filling tool according to the present invention are described using the following appropriate examples, but the invention is not limited to these examples.

The static crushing method according to the present invention is particularly characterized by using an aid for static crushing having a bottom plate placed within a drilled hole, a top plate which has an area greater than that of the bottom plate and is placed on the outside of the drilled hole, and a connection means for connecting the two.

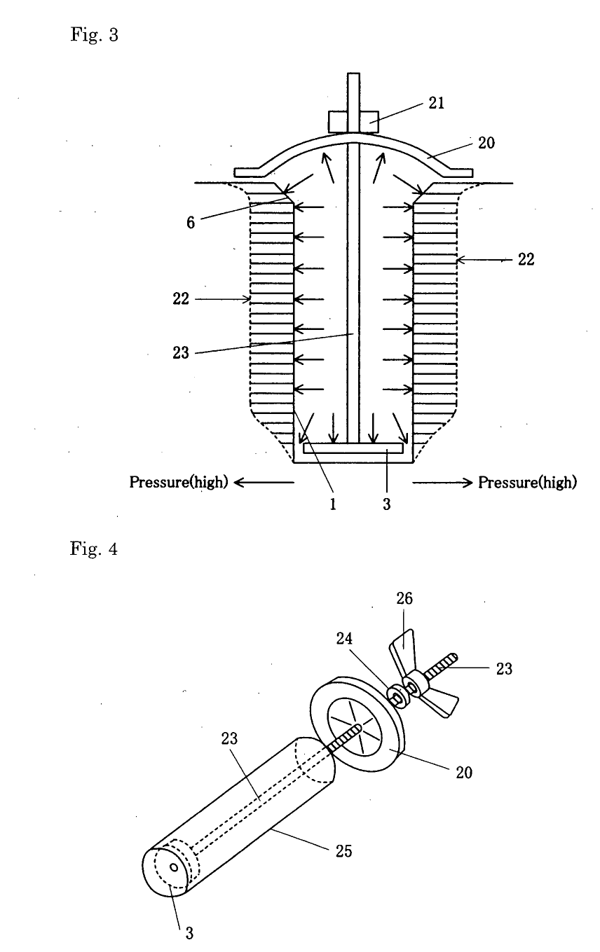

Concretely, in reference to FIG. 3, the principle of the aid for static crushing according to the present invention is described.

A drilled hole 1 is provided in an object to be crushed and a bottom plate 3 is placed inside the drilled hole 1, and a connection tool 23 linked to the bottom plate with a bolt or the like is provided through the drilled hole. A top plate 20 is connected to the upper portion of the connection tool 23 with a push nut 21 or the like, and the drilled hole is filled in with an expandable crushing material between the top plate 20 and the bottom plate 3.

As shown in FIG. 3, the top plate has an area greater than that of the bottom plate and is preferably formed so as to have an area greater than the area of the opening of the drilled hole 1, and at the same time, this top plate 20 is placed on the outside of the drilled hole 1, and thus, the drilled hole 1 with chipped portions 6 can be filled in with a sufficient amount of the expandable crushing material even in the vicinity of the opening of the drilled hole. Thus, the upward pressure is held by the top plate 20 so that it becomes possible for the pressure of the crushing material when expanding to create a crushing force which is significantly stronger than that of the prior art in the periphery of the opening of the drilled hole. For reference, FIG. 3 schematically illustrates the distribution of pressure 22 in the direction perpendicular to the direction of the drilled hole.

As shown in FIG. 3, according to the present invention, the area of the bottom plate is greater than the area of the top plate, and therefore, the downward force applied to the bottom plate is greater than the upward force applied to the top plate when the crushing material expands, and thus, there is a concern that the top plate may be lifted up. In practice, however, the friction force between the crushing material and the inner wall surface of the drilled hole 1 increases due to the expansion of the crushing material in the lateral direction, and therefore, it is confirmed that the top plate is barely lifted up.

As described above, the pressure is effectively applied to the drilled hole in the vicinity of the opening when the crushing material expands, and thus, the occurrence of cracking can be accelerated on the surface side of an object to be crushed, and as a result, the speed of crushing can be increased.

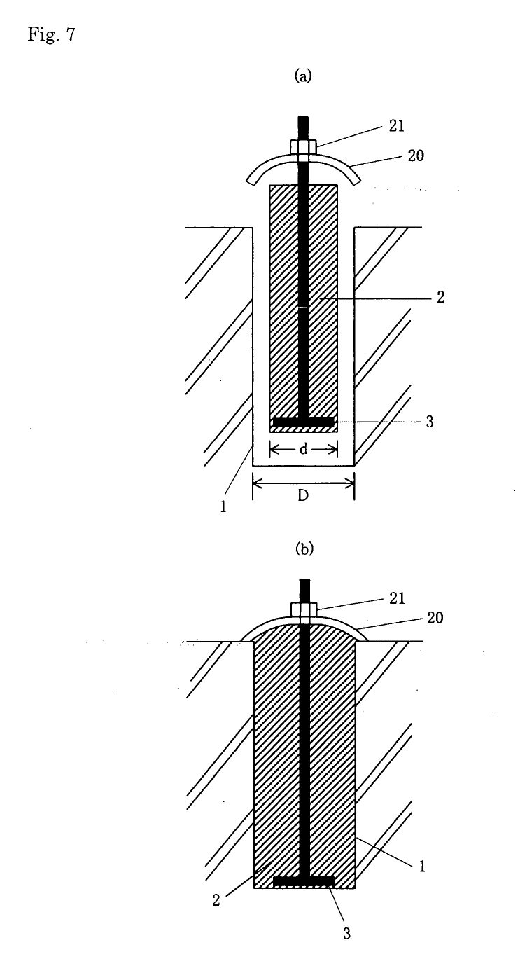

In addition, it is possible to add various types of configurations to the aid for static crushing according to the present invention, and for example, it is possible to use a convex clip plate as the top plate 20 to create a recess which covers the drilled hole on the drilled hole 1 side of the object to be crushed so that the amount of the expandable crushing material contained in the vicinity of the top plate can be increased, and the pressure can further be increased in the vicinity of the opening of the drilled hole when the crushing material expands. Here, various forms are possible for the top plate 20, and as shown in FIG. 6, for example, it is possible for the top plate to allow the pressure of the expandable crushing material 2 to by applied to the drilled hole 1 in the periphery of the opening by adjusting the strength and the area of the top plate, even in the case where a plate in disc form is used as the top plate 30.

A linking material in rod form, such as a bolt, or a linking material in string form, such as a wire, can be used as the connection tool 23 which forms the connection means, and various types of methods, such as a fixation method using a hook or a nut, a method for restricting the movement of the bottom plate by inserting a pin into the linking material, and a fixation method through welding or using an adhesive, can be adopted for the connection of the linking material and the bottom plate. In contrast, it is possible to use a nut or a pin to connect the top plate to the linking material, and preferably, as shown in FIG. 4, a screw is used as the entirety of the connection tool 23, and a push nut 26 is provided to the screw in such a manner as to be located at any connection point so that the push nut 26 can be moved and adjusted if necessary, making it possible for the top plate 20 to be removed from the connection means or to move along the connection means without the use of a particular tool.

Furthermore, the top plate 20 is formed so as to be freely removable from the connection tool 23 or so that the top plate 20 can approach or move away from the bottom plate 3, and thus, it is made possible to work where the top plate 20, the bottom plate 3 and the connection tool 23 are separate bodies as described in the following static crushing method, and it becomes possible to achieve an increase in the workability. In particular, in the case where the top plate is made to approach the bottom plate in a state where an expandable crushing material is placed between the top plate and the bottom plate, it becomes possible to increase the filling rate of the expandable crushing material so as to achieve a stronger pressure more quickly when the crushing material expands.

Though it is possible to use the aid for static crushing as a body separate from the expandable crushing material, it is possible for an expandable crushing material (not shown) to be contained inside a bag body 25 so that the aid for static crushing can be attached to a static crushing material, which is used as an integrated body, as shown in FIG. 4. Here, according to the present invention, an expandable crushing material contained in a bag body is referred to as “static crushing material,” and particularly, a static crushing material provided with an aid for static crushing is referred to as “static crushing material with an aid for static crushing” or “static crushing material with an aid.”

Concretely, a bottom plate 3 to which a connection tool 23, that is, a connection means, is attached is inserted into a bag body 25, and this bag body is filled in with a static crushing material. The opening of the bag body 25 is closed by an appropriate bonding means, such as heat sealing, and a top plate 20, a washer 24 and a push nut 26 are attached to the connection tool 23, which protrudes from the bag body 25.

A method for dividing an expandable crushing material into many pieces in capsule form for use where the expandable crushing material is contained in a water permeable bag body, such as of unwoven cloth or a net made of fiber, is simple and high in safety for the operators. In addition, as a means other than that shown in FIG. 4, though it is possible to make a connection tool penetrate through and attach to the static crushing material in capsule form, in this case, an opening is created in a portion through which the connection tool of the bag body penetrates, making the risk high of the expandable crushing material leaking from the opening, and therefore, it is preferable to contain the bottom plate 3 or the like inside the bag body as shown in FIG. 4.

Next, a static crushing method using the aid for static crushing according to the present invention is described in detail.

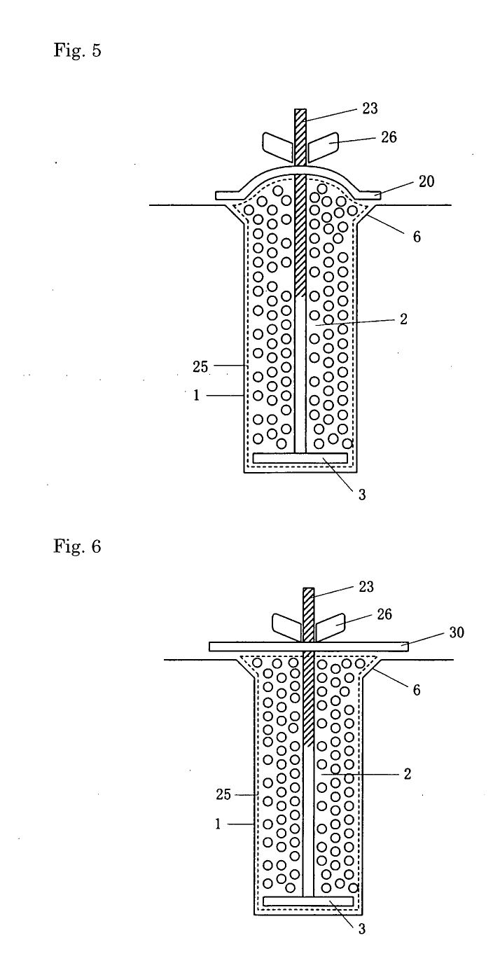

As shown in FIGS. 5 and 7, a static crushing material to which the aid of FIG. 4 is attached is installed inside the drilled hole 1 provided in an object to be crushed. The aid for static crushing is adjusted by moving the push nut after the aid is placed in the drilled hole 1 (see FIG. 7(a)) so that the top plate 20 and the bottom plate 3 approach each other, and the filling density of the expandable crushing material 2 placed between the two plates is increased (see FIG. 7(b)). This filling operation makes it possible for the pressure of the crushing material to increase quickly when expanding, and furthermore, for the pressure to effectively increase in the direction perpendicular to the direction of the drilled hole (lateral direction in the figure).

Furthermore, the aid for static crushing which is integrated with the bag body for containing the expandable crushing material is inserted into the drilled hole 1 of the object to be crushed as shown in FIG. 7(a), and at this time, the outer diameter d of the bottom plate 3 and a portion of the connection tool as well as the bag body for containing the expandable crushing material 2 is smaller than the inner diameter D of the drilled hole 1, and thus, it becomes possible for the aid for static crushing to be smoothly inserted into the drilled hole 1. After that, the push nut 21 is operated so that the top plate 20 approaches the bottom plate, and thus, the entirety of the bag body is compressed in the upward and downward directions in the figure, and at the same time, the expandable crushing material 2 contained in the bag body also expands in the lateral direction, and as a result, as shown in FIG. 7(b), it becomes possible for the drilled hole to be filled in with the crushing material 2.

When water is added to the expandable crushing material, the expansion reaction of the expandable crushing material is initiated, and as for the time when water is added, it is possible to add water at varying times in accordance with a method for adding water after the static crushing material with an aid is placed inside the drilled hole, a method for making the bag body 25 be contained within the drilled hole 1 after was is added to the static crushing material, or a method for making the bag body 25 be contained within the drilled hole 1 and adding water before the top plate 20 is fixed. In particular, it is preferable to add water before the static crushing material with an aid is inserted into the drilled hole in order to benefit from the ease of handling of the crushing material.

In addition, regarding the positional relationship between the top plate 20 and the object to be crushed, it is not necessary for the top plate 20 to make contact with the surface of the object to be crushed. Even when there is a gap between the two, for example, the gap between the two is filled in with the expandable crushing material as it expands, and as a result, it becomes possible for the top plate 20 to allow the internal pressure to be applied to the drilled hole 1 in the periphery of the opening so that crushing occurs through cracking in the vicinity of the opening of the drilled hole.

Though the static crushing method is described in the above by using a static crushing material with an aid as an example, it is also possible to place the bottom plate and the connection tool of the aid for static crushing inside the drilled hole, inject from the top a slurry of an expandable crushing material to which water is added, and after that, attach the top plate to the connection tool. In this case, it is not necessary to use a static crushing material where an expandable crushing material is contained within a bag body.

Next, application examples of the above described aid for static crushing are described.

The present inventors further continued diligent research on the above described aid for static crushing, and as a result, found that there are the following problems regarding the relationship between the length between the top plate and the bottom plate of the aid for static crushing (hereinafter, referred to as “length of the stick”) and the depth of the drilled hole of the object to be crushed.

(1) In the case of loading with the top plate being pressed toward the bottom plate, the state of filling of the expandable crushing material greatly changes depending on the depth of the drilled hole. As a result, the gained crushing effects are inconsistent.

(2) In the case where the depth of the drilled hole is greater than the length of the stick, the expandable crushing material does not spread in the lateral direction (direction perpendicular to the direction in which the top plate is pressed) even when the top plate is pressed, and thus, the aid for static crushing cannot be secured within the drilled hole, and in addition, the filling rate in the vicinity of the surface of the object to be crushed cannot be increased.

(3) In the case where the depth of the drilled hole is smaller than the length of the stick, the top plate lifts up from the object to be crushed, and in the case where the top plate sticks out greatly, it is difficult to temporarily press the top plate during processing. In addition, the bottom plate reaches the lower surface of the drilled hole, and therefore, the pressure is applied to the lower surface of the drilled hole when the crushing material expands so that the pressure applied in the lateral direction is reduced and an extra load is applied in the direction of the depth of the object to be crushed.

(4) It is technically difficult to provide a precisely drilled hole having a difference of +/−2 mm relative to the length of the stick.

An aid for static crushing which solves these problems, makes it possible to easily crush the surface of an object to be crushed irrelevant of the disparity of the depth of the drilled hole in the object to be crushed, and makes it easy to perform the crushing operation extremely safely and efficiently is described in the following.

In addition, this aid for static crushing makes it easy or unnecessary to temporarily press the top plate during processing, makes it easy to perform the operation of crushing more efficiently, and makes it possible to reduce the pressure applied to the lower surface of the drilled hole of the object to be crushed.

An application example of the aid for static crushing according to the present invention is characterized by providing a bottom plate placed inside the drilled hole, a top plate which has an area greater than that of the bottom plate and is placed on the outside of the drilled hole, and a connection means for connecting the two, where the connection means is provided with a fixation means for pulling the bottom plate toward the top plate so as to fix the bottom plate.

FIG. 9 is a schematic diagram showing a bag body 125 containing an expandable crushing material, not shown, inside to which an aid for static crushing of the application example is attached.

Concretely, a bottom plate 103 to which a connection tool 123, which is a connection means is attached, is inserted into the bag body 125, and this bag body is filled in with a static crushing material. The opening of the bag body 125 is closed with an appropriate binding means, such as heat sealing, and a top plate 120, a fixation means 126 and a pulling means 124 for pulling the connection tool are attached to the connection tool 123, which protrudes from the bag body 125.

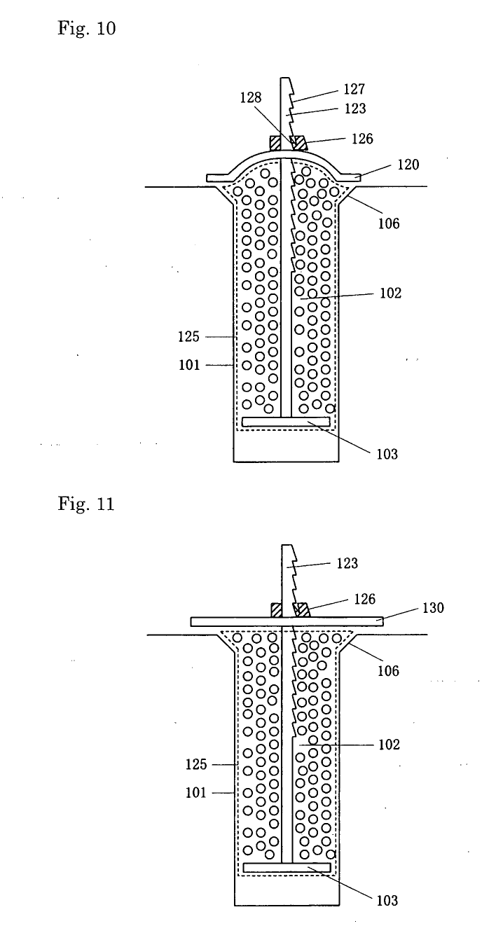

The static crushing material to which the aid of FIG. 9 is attached is installed inside the drilled hole 101 provided in an object to be crushed as shown in FIGS. 10 and 12.

The depth H of the drilled hole is provided so as to be deeper than the length (length of the stick) h between the top plate 120 and the bottom plate 103 (or bottom surface of the bag body) of the aid for static crushing.

Next, the drilled hole 101 is loaded with the aid for static crushing (see FIG. 12(a)), and after that, the connection tool 123 is pulled so that the bottom plate 103 is pulled toward the top plate 120, and the filling density of the expandable crushing material 102 placed between the two plates is increased and adjusted (see FIG. 12(b)). As a result of this filling operation, the application of the pressure of the crushing material is accelerated when the crushing material expands, and furthermore, it becomes possible to effectively apply high pressure in the direction perpendicular to the direction of the drilled hole (lateral direction in the figure) when the crushing material expands.

As described above, when the connection tool 123 is pulled, though the connection tool 123 moves upward relative to the fixation means 123, a configuration which makes the connection tool 123 move only in one direction (upward) is provided to the fixation means 121 as described below so that the connection tool 123 cannot return to its original location even when the pulling force is released, and therefore, it becomes possible to easily secure the aid for static crushing within the drilled hole.

Here, in the case of the present application example, the outer diameter d of the bottom plate 103 and a portion of the connection tool as well as the bag body for containing the expandable crushing material 102 is smaller than the inner diameter D of the drilled hole 101, and thus, it becomes possible to smoothly insert the aid for static crushing into the drilled hole 101. After that, the connection tool 123 is operated so that the bottom plate 103 approaches the top plate 120, and thus, the entirety of the bag body is compressed in the upward and downward directions in the figure, and at the same time, the expandable crushing material 102 contained in the bag body expands in the lateral direction, and as a result, as shown in FIG. 12(b), it becomes possible to fill in the drilled hole with the crushing material 102.

In addition, regarding the positional relationship between the top plate 120 and the surface of the object to be crushed, the depth H of the drilled hole is greater than the length h of the stick, and therefore, the top plate 120 makes contact with the surface of the object to be crushed, making it easy to temporarily press the top plate with a tape or the like during processing. In addition, the filling rate can be easily increased as described above, and therefore, in some cases it becomes unnecessary to temporarily press the top plate.

Any configuration can be adopted for the fixation means 126 as long as the connection tool 123 can be secured at a predetermined location, and as shown in FIG. 10 for example, protrusions in serrated form are created on at least one side of the connection tool 123 while a claw 128 for engaging a protrusion is provided to the fixation means so that the connection tool 123 can move only in one direction (upward) relative to the fixation means 126, and movement in the other direction (downward) is prohibited. As a result, when the connection tool 123 is pulled and after that the pulling force is released, the connection tool 123 does not return to its original location, and therefore, the operation of fixing the aid for static crushing can be easily performed.

In addition, it is possible to form such a fixation means integrally with the top plate 120, and when they are integrally formed, the number of parts of the aid for static crushing can be reduced and it becomes possible to easily perform the operation of loading the drilled hole with the aid by pulling the connection tool 123 while holding the top plate 120.

Furthermore, a fixation means can be easily formed by making the width of the opening through which the connection tool 123 for the top plate 120 penetrates smaller than the maximum width of the protrusions in serrated form created on the connection tool 123. Various types of publicly known technologies in the art can of course be applied for the fixation means.

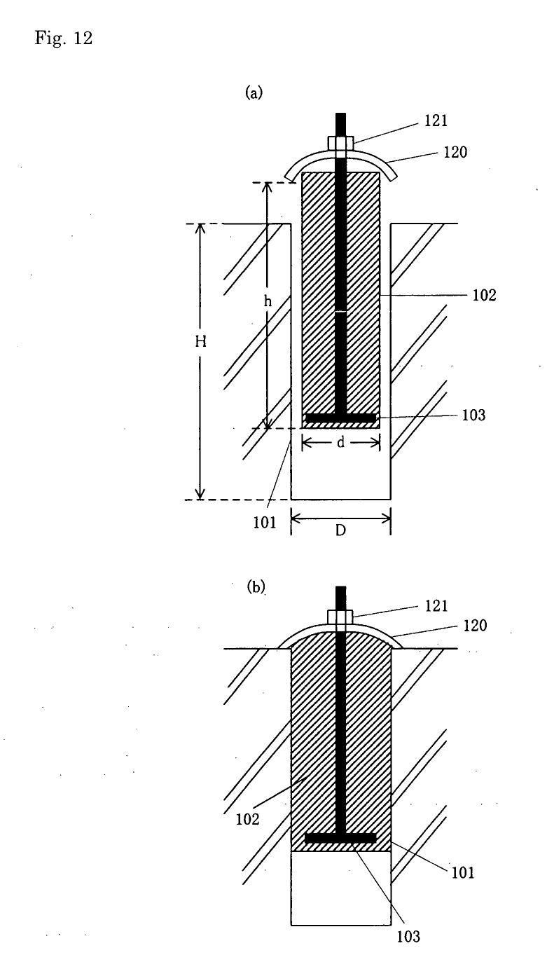

It is possible to provide various types of configurations to the aid for static crushing according to an application example, and a convex clip plate, for example, is used as the top plate so that a recess for covering the opening of the drilled hole is created on the drilled hole 101 side of the object to be crushed, and the amount of the expandable crushing material contained in the vicinity of the top plate is increased, making it possible to increase the pressure in the vicinity of the opening of the drilled hole when the crushing material expands. Here, various forms are possible for the top plate 120, and even when a plate in disc form is used as the top plate 130 as shown in FIG. 11, for example, it is possible to adjust the strength and the area of the top plate so that the top plate allows the pressure of the expandable crushing material 102 to be applied to the periphery of the opening of the drilled hole 101.

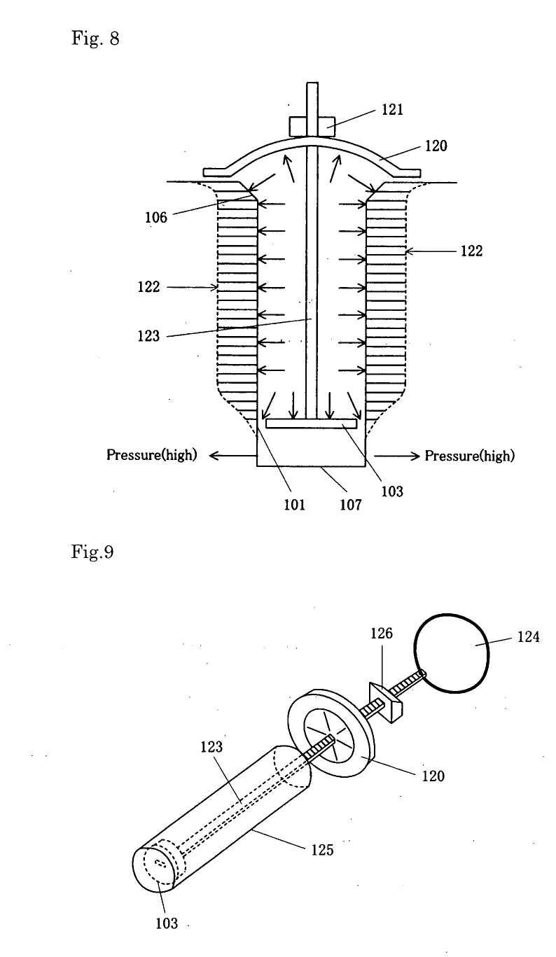

Next, the operation of the aid for static crushing, with which the drilled hole is filled in as described above, is described in reference to FIG. 8.

The bottom plate 103 is placed in the drilled hole 101 provided in an object to be crushed in a location at a distance from the lower surface 107 of the drilled hole 101. The top plate 120 is connected to the upper portion of the connection tool 123 with a fixation means 121, and the drilled hole is filled in with an expandable crushing material between the top plate 120 and the bottom plate 103.

As shown in FIG. 8, the top plate has an area greater than that of the bottom plate, and preferably, is formed so as to have an area greater than the area of the opening of the drilled hole 101, and at the same time, the top plate 120 is placed on the outside of the drilled hole 101 so that the drilled hole 101 can be sufficiently filled in with an expandable crushing material in the vicinity of the opening of the drilled hole having chipped portions 106. Thus, the upward pressure is held by the top plate 120 so that it becomes possible for the pressure of the crushing material when expanding to create a crushing force which is significantly stronger than that of the prior art in the periphery of the opening of the drilled hole. For reference, FIG. 8 schematically illustrates the distribution of pressure 122 in the direction perpendicular to the direction of the drilled hole.

As shown in FIG. 8, according to the present invention, the area of the bottom plate is greater than the area of the top plate, and therefore, the downward force applied to the bottom plate is greater than the upward force applied to the top plate when the crushing material expands, and thus, there is a concern that the top plate may be lifted up. In practice, however, the friction force between the crushing material and the inner wall surface of the drilled hole 101 increases due to the expansion of the crushing material in the lateral direction, and therefore, it is confirmed that the top plate is barely lifted up.

As described above, the pressure is effectively applied to the drilled hole in the vicinity of the opening when the crushing material expands, and thus, the occurrence of cracking can be accelerated on the surface side of an object to be crushed, and as a result, the speed of crushing can be increased.

In addition, as shown in FIG. 8, a gap is provided in the vicinity of the lower surface 107 of the drilled hole, and therefore, no pressure is applied to the bottom surface 107 of the drilled hole when the crushing material expands. Thus, almost no pressure is applied toward the inside of the object to be crushed when the crushing material expands so that the load applied to the inside of the object to be crushed can be reduced, making it possible to effectively crush the surface of the object to be crushed.

Next, a static crushing method for more efficient crushing using a deeply drilled hole and a filling tool used for the static crushing method are described.

In general, it is necessary to increase the depth of the drilled hole provided in the object to be crushed in order to destroy the entirety of the object to be crushed or destroy the object in a location deeper from the surface. Therefore, it is necessary to use a connection tool 23 or 123 having a length which is equal to or greater than the depth of the drilled hole in FIG. 3 or 8 in order to fill in a deeply drilled hole with a static crushing material provided with a static crushing aid.

As the length of the connection tool becomes greater, however, it becomes difficult to perform the operation of inserting a static crushing material into the drilled hole, and in addition, the operation of pulling the connection tool so that the filling density of the expandable crushing material can be increased becomes difficult in inverse proportion to the length of the connection tool.

In addition, it is indispensable to appropriately place the top plate in the vicinity of the opening of the drilled hole, and therefore, it is necessary to prepare aids for static crushing having various lengths corresponding to the depth of the drilled hole and static crushing materials to which the aids are incorporated, and thus, there is a disadvantage that the cost for manufacture becomes high.

A static crushing method which solves this problem, makes it possible to easily load the drilled hole with a static crushing material even in the case where the depth of the drilled hole of the object to be crushed is great, and makes it possible to perform the operation of crushing extremely safely and efficiently as well as a filling tool used for the static crushing method are described in the following.

A static crushing method using a deeply drilled hole is characterized by using a static crushing material with an aid, which is provided with an aid for static crushing as described above and where an expandable crushing material is contained within a water permeable bag body, and at least one or more static crushing materials without an aid, which are not provided with an aid and where an expandable crushing material is contained within a water permeable bag body so that the drilled hole is filled in with the static crushing materials without an aid, and the static crushing material with an aid is placed in the vicinity of the opening of the drilled hole.

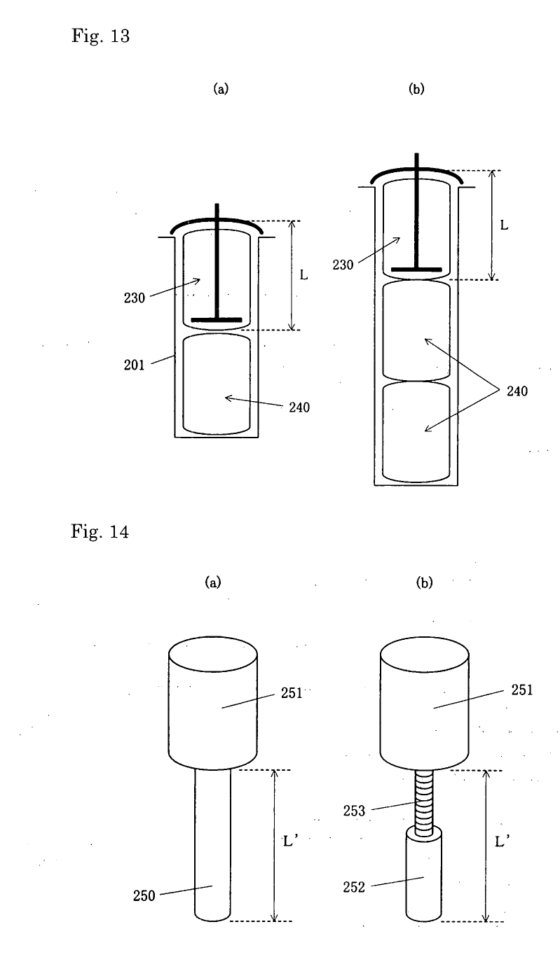

FIG. 13 is a diagram schematically showing the static crushing method according to the present invention, and as shown in FIG. 13(a) or 13(b), one or more static crushing materials without an aid 240 are placed inside a drilled hole 201 and a static crushing material with an aid 230 is placed in the vicinity of the opening of the drilled hole.

It is possible to use a static crushing material having an aid as shown in FIG. 4 or 9, for example, as the static crushing material with an aid 230.

In addition, though it is possible for the static crushing materials without an aid 240 to start expanding at the same time as the time when the static crushing material with an aid 230 starts expanding, it is preferable for the time to be set at a later time. This is because it becomes possible to efficiently destroy the object to be crushed when the static crushing material with an aid, with which the vicinity of the opening of the drilled hole is filled in, initially expands, providing a state where the vicinity of the opening of the drilled hole is firmly and tightly closed, and even when the static crushing materials without an aid placed inside the drilled hole expands afterwards, the expansion of the crushing material progresses with the vicinity of the opening of the drilled hole being covered with the static crushing material with an aid. In addition, the static crushing materials without an aid are prevented from blowing out from the opening of the drilled hole due to the effects of the static crushing material with an aid covering the vicinity of the opening of the drilled hole, and thus, the operation can be performed extremely safely.

It is possible to easily adjust the time when expansion starts by adjusting the amount of a reaction accelerator mixed in the expandable crushing material and the temperature of water when the static crushing material absorbs the water.

It is preferable for the length L of the stick of the static crushing material with an aid to be 100 mm or shorter. Though depending on the size of the inner diameter of the drilled hole, when L exceeds 100 mm, it becomes difficult to load the drilled hole with a static crushing material with an aid, and in addition, it becomes difficult to increase the filling rate of the expandable crushing material throughout the entirety of the static crushing material even when the connection means of the aid is operated (for example, the operation of pulling up the pulling means 124 connected to the connection tool 123 of FIG. 9 relative to the fixation means 126) in a state where the static crushing material with an aid is placed inside the drilled hole.

Next, the filling tool according to the present invention is characterized by having a portion in rod form having an outer diameter smaller than the inner diameter of the drilled hole and a pressing portion which is directly or indirectly connected to the portion in rod form and has an outer diameter greater than the inner diameter of the drilled hole.

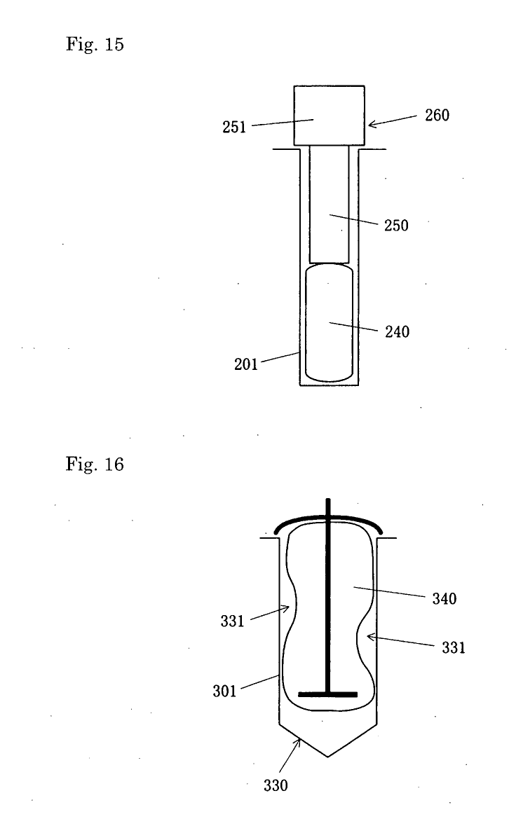

FIG. 14 is a diagram schematically showing filling tools, and FIG. 15 is a diagram showing a manner in which a drilled hole is filled in with a static crushing material without an aid 40 using a tool.

The filling tool of FIG. 14(a) is formed of a portion in rod form 250 having an outer diameter smaller than the inner diameter of the drilled hole and a pressing portion 251 which is directly connected to the portion in rod form 250 and has an outer diameter greater than the inner diameter of the drilled hole. The form of the portion in rod form 250 and the pressing portion 251 is not limited to a columnar form as shown in FIG. 14, but may be a prism form, and furthermore, it is possible for the pressing portion 251 to have a form with smooth unevenness which fits the form of a hand, making it easy for the worker to grip.

Regarding the filling tool, as shown in FIG. 15, a static crushing material without an aid 240 is placed inside a drilled hole 201, and the static crushing material 240 is pressed with a filling tool 260, and thus, it becomes possible to easily fill in the drilled hole with a static crushing material. In addition, the diameter of the filling tool 260 is set so that it becomes difficult for the pressing portion 251 to enter into the drilled hole 201, and therefore, it is possible to always fill in the drilled hole with a static crushing material 240 up to a certain depth when the filling tool is pressed into a drilled hole, a hitting means, such as a hammer, is used if necessary, and the head of the pressing portion 251 keeps being hit so that it becomes possible to easily fill in the drilled hole with a static crushing material.

The location in which the drilled hole is filled in with the static crushing material without an aid 240 (distance between the opening of the drilled hole and the upper end of the static crushing material) is determined by the length L′ of the portion in rod form 250 of the filling tool, and it is preferable for the length L′ to be the same as the length of the portion of the static crushing material with an aid which has entered into the drilled hole.

Furthermore, as shown in FIG. 14(b), when a screw 253 or the like is used, it is possible to connect the portion in rod form 252 and the pressing portion 251 and also to make the distance the distance between the two adjustable. In this case, it becomes possible to adjust the length L′ between the end of the portion in rod form 252 and the pressing portion 251 in accordance with the length of the used static crushing material with an aid.

Next, a static crushing method using a static crushing material with an aid and a slurry of an expandable crushing material is described.

When a static crushing material with an aid is inserted into a drilled hole, as shown in FIG. 16, in the case where the depth of the drilled hole 301 is greater than the length of the static crushing material 340 or in the case where the deepest portion of the drilled hole is in cone form corresponding to the form of the tip of the drill for drilling, a cavity 330 is created within the drilled hole even when the drilled hole 301 is loaded with the static crushing material 340. This cavity 330 causes a major problem in the case where the inside of the object to be crushed is desired to be destroyed efficiently in addition to the surface. Furthermore, in the case where there are many gaps between the bottom plate and the inner wall of the drilled hole, the expanded expandable crushing material enters into the cavity, preventing a sufficient amount of pressure from being applied when the crushing material expands.

In addition, in the case where the aid of the static crushing material 340 is operated so that the distance between the top plate and the bottom plate is shortened and the filling rate of the expandable crushing material is increased, the filling rate only partially increases, and in some cases, gaps 331 are created as shown in FIG. 16. In particular, as the length of the static crushing material becomes greater, this tendency becomes significant. These gaps 331 become a great hindrance in applying a sufficient amount of pressure when the expandable crushing material expands.

A static crushing method which solves such problems and makes it possible to efficiently perform the crushing operation in the case where a cavity or a gap is created between the drilled hole and the static crushing material is described in the following.

This static crushing method is characterized by providing a static crushing material with an aid, which is provided with an aid for static crushing and where an expandable crushing material is contained within a water permeable bag body, making the static crushing material with an aid absorb water, and loading the drilled hole with the static crushing material with an aid in accordance with either the following two methods or a combination of both of the following two methods.

(A) A slurry containing an expandable crushing material is injected into a drilled hole in advance.

(B) A slurry containing an expandable crushing material is made to adhere to a static crushing material that has absorbed water.

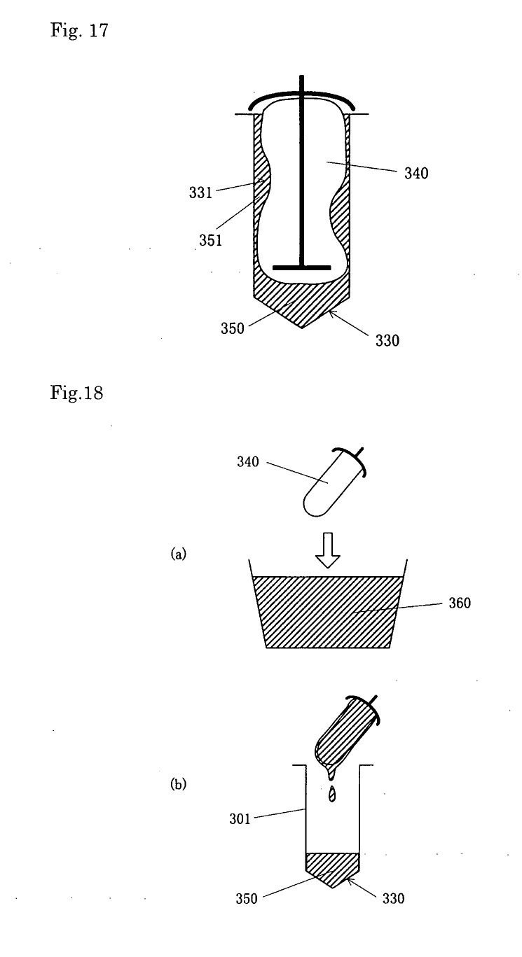

In accordance with this static crushing method, as shown in FIG. 17, a cavity 330 or gaps 331 within the drilled hole can be filled in with a slurry 350 or 351 containing an expandable crushing material, and thus, it becomes possible to more effectively gain a force of the expandable crushing material when the crushing material expands.

In particular, the slurry injection method of the above (A) is effective in order to fill in the cavity 330 with the slurry 350, and the method for attaching the slurry to the static crushing material of the above (B) is effective in order to fill in the gaps 331 with the slurry 351.

FIG. 18 is a diagram illustrating an example of the static crushing method where the above described (A) and (B) are combined, and a static crushing material with an aid 340 that has absorbed water in advance is immersed in a slurry 360, which has been prepared by adding water to an expandable crushing material, so that the slurry 60 adheres to the static crushing material with an aid 340 (see FIG. 18(a)). Next, a slurry 350 containing an expandable crushing material is injected into the drilled hole provided to an object to be crushed, and after that, the drilled hole is loaded with the static crushing material with an aid to which the slurry 360 adheres. Though the same slurry may be used as the slurry 350 or 360, it is possible to prepare different types of slurries, taking the below described time when the expansion starts and the viscosity into consideration.

Next, the time when the static crushing material and the slurry expand is described.

In accordance with this static crushing method, it is preferable for the time when the slurry starts expanding to be later than the time when the static crushing material with an aid starts expanding. As a result, the static crushing material with an aid initially expands, and the effects of firmly and tightly closing the vicinity of the opening of the drilled hole and the effects of pressing the slurry that has adhered to the surrounding of the static crushing material with an aid toward the inner wall of the drilled hole so that the filling rate of the slurry increases can be expected.

Here, in the case where the slurry within the drilled hole is used together with the static crushing material as described above, the slurry is heated by the reaction heat from the static crushing material, and therefore, it becomes possible to shorten the time after the filling operation and before the start of crushing in comparison with a conventional crushing method using only a slurry.

It is possible to easily adjust the time when expansion starts by adjusting the amount of a reaction accelerator mixed in the expandable crushing material and the temperature of water when the static crushing material absorbs the water.

Next, the adjustment of the viscosity of the slurry is described.

The viscosity of the slurry can be adjusted by adding a thickener, and the viscosity of the slurry can be controlled, for example, by selecting the type and adjusting the amount of the added thickener while maintaining the amount of water relative to the expandable crushing material constant in order to make the expandable crushing material react sufficiently.

By adjusting the viscosity in this manner, for example, it becomes possible to prevent such harmful effects that the slurry that has adhered to the static crushing material sags during the operation of filling and the slurry that has been injected into the drilled hole flows out from the opening of the drilled hole.

Methyl cellulose and the like can be used as the thickener.

In particular, when the slurry injected into the drilled hole has such a viscosity as not to flow out even when the drilled hole is a lateral hole and a self-shape maintaining property, the operation of crushing can be efficiently performed using the expandable crushing material even when the drilled hole is a lateral hole. It is preferable for the amount of the added thickener to be approximately 0.5% to 3.0%.

In addition, the static crushing method using a slurry can be used in the same manner in the case where a drilled hole is filled in with a static crushing material without an aid as described above, and it is possible to fill in the drilled hole with the slurry of the expandable crushing material in advance, insert the static crushing material without an aid afterwards, or insert a static crushing material without an aid to which a slurry has adhered into the drilled hole.

### INDUSTRIAL APPLICABILITY

As described above, according to the present invention, a static crushing method which makes it possible to easily crush the surface of an object to be crushed and makes it possible to perform the crushing operation extremely safely and efficiently, an aid for static crushing used for the static crushing method and a filling tool can be provided. In particular, the invention can be effectively used in crushing a concrete structure, such as a building and a tunnel, and can be easily applied to a location, such as a ceiling portion, an upper surface portion and a side surface portion where crushing is difficult according to the prior art in addition to a lower surface portion of the above described structures, and in addition, it becomes possible to simply and efficiently crush a structure irrelevant of the shape of the drilled hole at the time of the crushing operation.

1. A static crushing method, comprising the steps of:
providing a drilled hole in an object to be crushed;
filling in the drilled hole with an expandable crushing material, and with an aid for static crushing,
said aid for static crushing comprising
a bottom plate that is placed within the drilled hole,
a top plate which has an area greater than an area of the bottom plate, and which is placed on an outside of the drilled hole, and
a connection means for connecting the bottom plate with the top plate,
wherein the expandable crushing material is placed between the bottom plate and the top plate; and
crushing the object by expansion of the expandable crushing material.

2. The static crushing method according to claim 1, wherein the expandable crushing material is contained inside a water permeable bag body.

3. The static crushing method according to claim 2, wherein the expandable crushing material is integrated with the connection means and with one or more of the bottom plate and the top plate.

4. The static crushing method according to claim 2, further comprising the step of:
adding water to the expandable crushing material before filling in the drilled hole with the expandable crushing material.

5. The static crushing method according to claim 1, further comprising the step of:
causing the bottom plate and the top plate to approach each other after the drilled hole of the object to be crushed has been filled in with the expandable crushing material, thereby increasing a filling ratio of the expandable crushing material between the bottom plate and the top plate.

6. The static crushing method according to claim 1, further comprising the step of:
filling in the drilled hole with at least one static crushing material without an aid for static crushing, wherein
a static crushing material with an aid for static crushing comprises the aid for static crushing, and has expandable crushing material contained within a water permeable bag body,
a static crushing material without an aid for static crushing is not provided with the aid for static crushing, and has expandable crushing material contained within a water permeable bag body, and
the static crushing material with an aid for static crushing is placed in a vicinity of an opening of the drilled hole.

7. The static crushing method according to claim 6, wherein a start time of expansion of said at least one static crushing material without an aid occurs at or after a start time of expansion of the static crushing material with an aid.

8. The static crushing method according to claim 6, wherein a length between the top plate and the bottom plate of the aid for static crushing is no greater than 100 mm.

9. A filling tool for filling in the drilled hole with the static crushing material without an aid for static crushing, in accordance with the static crushing method according to claim 6, comprising
a portion in rod form having an outer diameter smaller than an inner diameter of the drilled hole, and
a pressing portion directly or indirectly connected to the portion in rod form, having an outer diameter greater than the inner diameter of the drilled hole.

10. The filling tool according to claim 9, wherein a distance between the portion in rod form and the pressing portion is adjustable.

11. The static crushing method according to claim 1, further comprising the steps of:
making a slurry including an expandable crushing material, by causing to absorb water
a static crushing material with an aid for static crushing, comprising the aid for static crushing, and having expandable crushing material contained within a water permeable bag body;
and then loading the drilled hole with the static crushing material with an aid.

12. The static crushing method according to claim 1,
further comprising the steps of:
making a slurry including an expandable crushing material, by causing to absorb water
a static crushing material with an aid for static crushing, comprising the aid for static crushing, and having expandable crushing material contained within a water permeable bag body;
and then immersing the static crushing material with an aid into a second slurry including an expandable crushing material, causing the second slurry to adhere to the static crushing material with an aid;
and then loading the drilled hole with the static crushing material with an aid.

13. The static crushing method according to claim 1,
further comprising the steps of:
making a slurry including an expandable crushing material, by causing to absorb water
a static crushing material with an aid for static crushing, comprising the aid for static crushing, and having expandable crushing material contained within a water permeable bag body;
and then immersing the static crushing material with an aid into a second slurry including an expandable crushing material, causing the second slurry to adhere to the static crushing material with an aid;
injecting a third slurry including an expandable crushing material into the drilled hole;
and then loading the drilled hole with the static crushing material with an aid.

14. The static crushing method according to claim 11, wherein a start time of expansion of the slurry occurs later than a start time of expansion of the static crushing material with an aid.

15. The static crushing method according to claim 11, wherein a viscosity of the slurry is adjusted by means of an added thickener.

16. The static crushing method according to claim 15, wherein the slurry has a viscosity and a self-shape maintaining property so as not to flow out of the drilled hole, even in a case where the drilled hole is a lateral hole.

17. An aid for static crushing used in a static crushing method that includes providing a drilled hole in an object to be crushed, filling in the drilled hole with an expandable crushing material, and crushing the object by expansion of the expandable crushing material, said aid comprising:
a bottom plate that is placed within the drilled hole;
a top plate which has an area greater than an area of the bottom plate, and which is placed on an outside of the drilled hole; and
a connection means for connecting the bottom plate with the top plate.

18. The aid for static crushing according to claim 17, wherein the top plate has an area greater than an area of an opening of the drilled hole.

19. The aid for static crushing according to claim 17, wherein the top plate is formed so as to be freely removable from the connection means.

20. The aid for static crushing according to claim 17, wherein a recess which covers an opening of the drilled hole is formed in the top plate on the drilled hole side of the object to be crushed.

21. The aid for static crushing according to claim 17, wherein the top plate is formed in such a manner that the connection means allows the top plate to approach or move away from the bottom plate.

22. The aid for static crushing according to claim 17, wherein the connection means has a fitting for maintaining and securing a state of being connected to the top plate.

23. The aid for static crushing according to claim 17, wherein the connection means is provided with a fixation means for fixing the bottom plate, which is pulled toward the top plate.

24. The aid for static crushing according to claim 23, wherein the fixation means makes the connection means moveable only in a direction in which the bottom plate is pulled toward the top plate.

25. The aid for static crushing according to claim 23, wherein the top plate and the fixation means are integrally formed.

26. The aid for static crushing according to claim 17, wherein the expandable crushing material is contained within a water permeable bag body and placed between the bottom plate and the top plate.

27. The aid for static crushing according to claim 26, wherein the bottom plate is placed within the bag body.

28. The static crushing method according to claim 2, further comprising the step of:
adding water to the expandable crushing material after filling in the drilled hole with the expandable crushing material.
